(19) United States
(12) Patent Application Publication
(10) Pub. No.: US 2012/0032776 A1
(43) Pub. Date: Feb. 9, 2012

(54) ELECTRONIC SYSTEM AND METHOD OF CONTROLLING THE SAME

(75) Inventors: Po-Yen Wu, Hsin-Chu (TW); Po-Jen Chang, Hsin-Chu (TW)

(73) Assignee: CORETRONIC CORPORATION, Hsin-Chu (TW)

(21) Appl. No.: 13/164,787

(22) Filed: Jun. 21, 2011

(30) Foreign Application Priority Data
Aug. 5, 2010 (CN) 201010247376.4

(51) Int. Cl. G05B 19/00

(52) U.S. Cl. 340/5.6

(57) ABSTRACT

An electronic system and a method of controlling the same are provided. The electronic system has an electronic device and a remote controller. The electronic device has a storage unit for storing a first password. The remote controller is used to control the operations of the electronic device. When a switch module of the remote controller is pressed, the remote controller generates a power on signal. The power on signal has a power on command and a second password. When the first password and the second password are the same, the electronic device is permitted to complete a power on operation according to the power on command. Accordingly, the electronic system has an anti-theft function.

### CROSS-REFERENCE TO RELATED APPLICATION

This application claims the priority benefit of China application serial no. 201010247376.4, filed Aug. 5, 2010. The entirety of the above-mentioned patent application is hereby incorporated by reference herein and made a part of this specification.

### BACKGROUND OF THE INVENTION

1. Field of the Invention

The invention relates to an electronic system and a method of controlling the same, and more particularly to an electronic system and a control method thereof having an anti-theft function.

2. Description of the Related Art

An anti-theft mechanism of a typical electronic device is achieved through establishing a user password. Before the user operates the electronic device, the user is requested to enter a password. Only when the entered password is correct, the user is permitted to operate the electronic device normally. When the entered password is incorrect, then the electronic device cannot be successfully powered on for use.

However, the password input method described above may lead to an issue of stolen passwords. For example, while entering the password, someone is up to no good may peep at the password user entered. Hence, this method is limited in preventing the electronic device from being misused or stolen. Moreover, after a user applies to use a conference room, the user gains access to the passwords to the electronic devices (e.g., a projector) in the conference room. If the passwords are not changed, then the user can still operate the password-protected electronic equipments without re-applying for the conference room, and thus the electronic devices therein may be misused. Additionally, even if the passwords of the electronic devices are changed after each use of the conference room, such frequent password changes lead to inconvenience in management.

Taiwan Patent No. M319464 discloses an electronic device having an electronic device body, a remote control unit, an identification unit, and a tag. The remote control unit has a first switch. The identification unit is disposed to the electronic device body, and the tag is disposed to the remote control unit. When the remote control unit approaches the electronic device body, and the first switch is turned on, the identification unit performs an identifying process on the tag to power on the electronic device body. The electronic device body is permitted to power on only after the identification unit identifies the tag. The tag and the identification unit may be a radio frequency (RF) tag and a RF unit, respectively.

Taiwan Patent Publication No. 200846966 discloses an anti-theft device and a method of preventing an electronic device from usage by an unauthorized user. The anti-theft device has an anti-theft module and an identification device. The anti-theft module and the identification device can communicate with each other by wireless communication, and the anti-theft module is disposed inside the electronic device while the identification device is disposed outside of the electronic device. The anti-theft module sends an identification startup signal to the identification device when the power switch of the electronic device is turned on. The identification device is turned on when the identification startup signal is received, and a coded signal generated by encoding an identification code stored in the identification device is transmitted to the anti-theft module. The anti-theft module decodes the coded signal and examines whether the decoded signal is the accurate identification code. When the decode signal is the identification code, the anti-theft module actuates the operation of the electronic device.

### SUMMARY OF THE INVENTION

The invention is directed that an electronic system determines whether a user is using the correct remote controller to power on the electronic device according to the password in the power on signal of the remote controller, thereby achieving an anti-theft function.

The invention is directed to a method of controlling an electronic system, in which the password in the power on signal of the remote controller used to control the electronic device is compared with the password of the electronic device. Only when the two passwords are the same, the remote controller is permitted to remotely control the electronic device.

Other objects and advantages of the invention could be further illustrated by the technical features broadly embodied and described as follows.

In summary, the embodiment or embodiments of the invention may have at least one of the following advantages. An embodiment of the invention provides an electronic system. The electronic system includes an electronic device and a remote controller. The electronic device has a first storage unit for storing a first password. The remote controller is used to control the operations of the electronic device. The remote controller has a switch module and a transmission module. The switch module is used to generate a power on signal. The power on signal has a power on command and a second password. The transmission module is used to transmit the power on signal to the electronic device. The electronic device decodes the power on command and the second password of the power on signal, and compares the first password stored in the first storage unit with the second password decoded by the electronic device. When the first password and the second password are the same, the electronic device is permitted to complete a power on operation according to the power on command.

An embodiment of the invention further provides a method of controlling an electronic system. The electronic system has an electronic device and a remote controller. The electronic device has a first storage unit for storing a first password. The method of controlling the electronic system comprises the following steps. A switch module of the remote controller is pressed to generate a power on signal having a power on command and a second password. Through a transmission module of the remote controller, the power on signal is wirelessly transmitted to the electronic device. The electronic device decodes the power on command and the second password of the power on signal. Moreover, the electronic device compares the first password stored in the first storage unit with the second password decoded by the electronic device. When the first password and the second password are the same, the electronic device is permitted to complete a power on operation according to the power on command.

According to an embodiment of the invention, when the electronic device receives the power on signal, the electronic device checks whether the first password is stored in the first storage unit. If the first password is not stored in the first storage unit, then the electronic device makes the second password of the power on signal be stored in the first storage unit to serve as the first password.

According to an embodiment of the invention, when the electronic device consecutively compares the first password with the second password and results in a frequency of consecutive incorrect password entries over a predetermined frequency, the electronic device is maintained in a standby mode.

According to an embodiment of the invention, the first storage unit further stores a third password. When the electronic device receives a fourth password from outside, and when the fourth password and the third password are the same, the electronic device is permitted to reset the first password by storing a fifth password in the first storage unit to serve as the first password according to a power on signal sent from another remote controller, and the power on signal has a power on command and the fifth password.

According to an embodiment of the invention, the remote controller has a second storage unit for storing the second password.

In summary, according to the embodiments of the invention described above, the password in the power on signal of the remote controller used to control the electronic device is compared with the password of the electronic device. Only when the two passwords are the same, the remote controller is permitted to remotely control the electronic device. Moreover, by determining whether the user is using the correct remote controller to power on the electronic device according to the password in the power on signal of the remote controller, the anti-theft function is achieved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an electronic system according to an embodiment of the invention.

FIG. 2 is a flowchart of a method of controlling the electronic system according to an embodiment of the invention.

FIG. 3 is a flowchart of an initialization process of the electronic device of the electronic system according to an embodiment of the invention.

FIG. 4 is a flowchart of a process of resetting the first password according to an embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

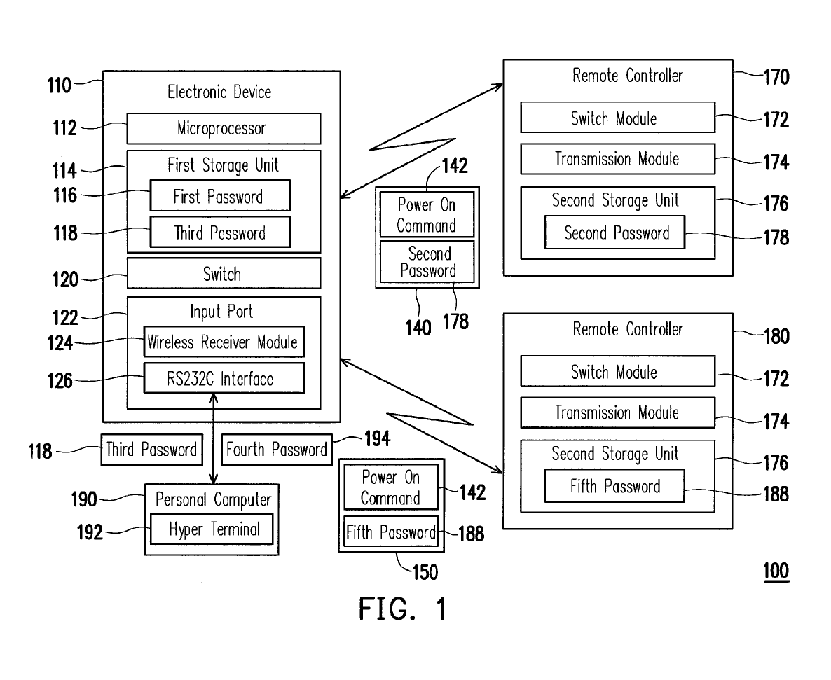

Referring to FIG. 1, FIG. 1 is a functional block diagram of an electronic system 100 according to an embodiment of the invention. The electronic system 100 has an electronic device 110 and a remote controller 170. The remote controller 170 is used to control the operations of the electronic device 110. The electronic device 110 has a first storage unit 114 for storing a first password 116. The remote controller 170 has a switch module 172 and a transmission module 174. In the embodiment, the switch module 172 is a key, and the transmission module 174 is an infrared (IR) transmitter. Nevertheless, the invention should not be construed as limited thereto. For example, the switch module 172 may be a touch panel, a two step switching switch, a transistor, and so on, while the transmission module 174 may be a RF device, a laser emitter, and so on.

The switch module 172 is used to generate a power on signal 140. The power on signal 140 has a power on command 142 and a second password 178. The transmission module 174 is used to transmit the power on signal 140 to the electronic device 110. In the present embodiment, the electronic device 110 further has a microprocessor 112. Through the microprocessor 112, the electronic device 110 decodes the power on command 142 and the second password 178 in the power on signal 140, and compares the first password 116 stored in the first storage unit 114 with the second password 178 decoded by the electronic device 110. When the first password 116 and the second password 178 are the same, the electronic device 110 is permitted to complete a power on operation according to the power on command 142. In the embodiment, the remote controller 170 further has a second storage unit 176 for storing the second password 178. Moreover, in the present embodiment, the first storage unit 114 may be a non-volatile memory such as an electrically erasable programmable read only memory (EEPROM) and a flash memory.

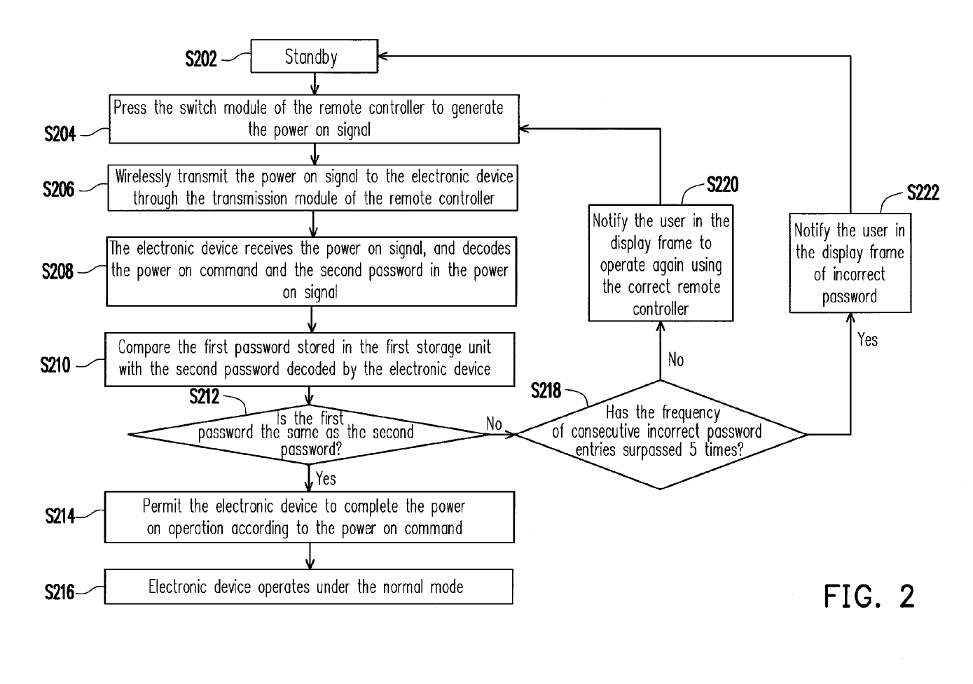

Referring to both FIGS. 1 and 2, FIG. 2 is a flowchart of a method of controlling the electronic system 100 according to an embodiment of the invention. Before the electronic device 110 is powered on, the electronic device 110 is in a standby mode (Step S202). When the electronic device 110 is in the standby mode, although the electronic device 110 is connected to a power source, most of the components in the electronic device 110 are in an inactive, non power consuming state, besides a small portion of the components (e.g., an input port 122). Thereafter, the user presses the switch module 172 of the remote controller 170 for generating the power on signal 140 (Step S204). The power on signal 140 is wirelessly transmitted by the transmission module 174 of the remote controller 170 to the electronic device 110 (Step S206). The electronic device 110 receives the power on signal 140 through a wireless receiver module 124 of the input port 122, and through the microprocessor 112, the electronic device 110 decodes the power on command 142 and the second password 178 in the power on signal 140 (Step S208). Thereafter, through the microprocessor 112, the electronic device 110 compares the first password 116 stored in the first storage unit 114 with the second password 178 decoded by the electronic device 110 (Step S210). In a Step S212, the electronic device 110 determines whether the first password 116 and the second password 178 are the same through the microprocessor 112. When the first password 116 and the second password 178 are the same, the electronic device 110 is permitted to complete a power on operation according to the power on command 142 (Step S214). It should be noted that, the remote controller 170 may also generate other signals other than the power on signal 140, and these other signals may include commands other than the power on command 142, for example, commands such as up, down, left, right, and so on. Before the electronic device 110 completes the power on operation according to the power on command 142, even if the electronic device 110 receives signals other than the power on signal 140, the electronic device 110 does not execute the corresponding operations. The commands in the signals other than the power on signal 140 are only operable after the electronic device 110 completes the power on operation according to the power on command 142. After the electronic device 110 completes the power on operation according to the power on command 142, the electronic device 110 is operating in a normal mode (Step S216). The normal mode refers to most of the components in the electronic device 110 coming off the originally inactive, non power consuming state.

Moreover, in the Step S212, when the first password 116 and the second password 178 are not the same, the electronic device 110 further determines whether a frequency of consecutive incorrect password entries has surpassed a predetermined frequency (Step S218). In the present embodiment, the predetermined frequency is 5 times, although the invention is not limited thereto, and the predetermined frequency may be other frequencies. When the frequency of consecutive incorrect password entries has not surpassed the predetermined frequency, the electronic device 110 notifies the user on a display frame to retry using the correct remote controller (Step S220), and the process from Steps S204-S212 is executed again. In the embodiment of the invention, the electronic device 110 is a projector, and the display frame is an image projected by the projector. In the embodiment of the invention, the electronic device 110 further has a display device, and the display frame is the image displayed by the display device. Moreover, in the embodiment of the invention, the electronic device 110 connects to an external display device, and the display frame is the image displayed by the external display device. Conversely, when it is determined in Step S218 that the frequency of consecutive incorrect password entries has surpassed the predetermined frequency, then the display frame notifies the user of the incorrect password (Step S222), and the electronic device 110 is returned to the standby mode.

As illustrated in the above process, when the first password 116 and the second password 178 are not the same, the electronic device 110 could not complete the power on operation according to the power on command 142. Therefore, the electronic device 110 is permitted to complete the power on operation only when the user remotely controls the electronic device 110 through the remote controller 170 having the second password 178 the same as the first password 116. Accordingly, the electronic system 100 has an anti-theft mechanism.

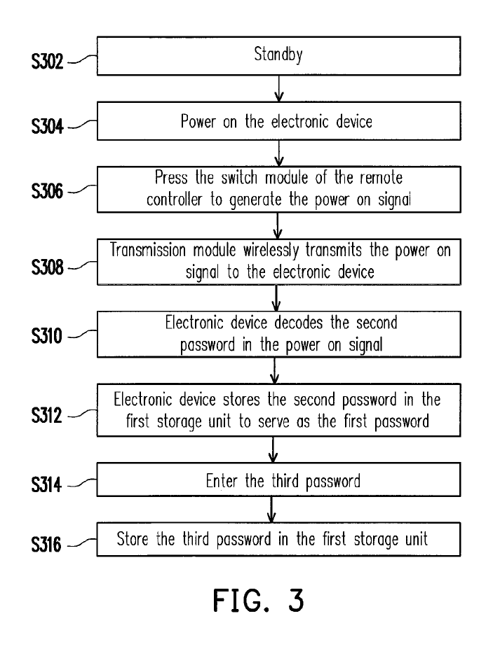

Moreover, in order to preclude the possibility of unable-starting of the electronic device 110 due to damage of the remote controller 170, the control method in the embodiment of the invention further has a mechanism for resetting the first password 116. In order to achieve the mechanism of resetting the first password 116, in the embodiment of the invention, the first storage unit 114 further stores a third password 118. The third password 118 is stored in the first storage unit 114 through an initialization process when the electronic device 110 is first being used. Referring to FIGS. 1 and 3, FIG. 3 is a flowchart of an initialization process of the electronic device 110 of the electronic system 100 according to an embodiment of the invention, illustrating the setting of the first password 116 and the third password 118 when the electronic device 110 is used for the first time. Before setting the electronic device 110, the electronic device 110 is in the standby mode (Step S302). Thereafter, through a switch 120 of the electronic device 110, the electronic device 110 is powered on (Step S304). The user presses the switch module 172 of the remote controller 170 for generating the power on signal 140 (Step S306). Next, the power on signal 140 is wirelessly transmitted by the transmission module 174 of the remote controller 170 to the electronic device 110 (Step S308). The electronic device 110 receives the power on signal 140 through the wireless receiver module 124 of the input port 122, and through the microprocessor 112, the electronic device 110 decodes the second password 178 in the power on signal 140 (Step S310). When the electronic device 110 receives the power on signal 140, the electronic device 110 checks whether the first password 116 is stored in the first storage unit 114. If the first password 116 is not stored in the first storage unit 114, then the electronic device 110 stores the second password 178 of the power on signal 140 in the first storage unit 114 to serve as the first password 116 (Step S312). Thereafter, the user enters the third password 118 through the remote controller 170 (Step S314), such that the electronic device 110 stores the third password 118 in the first storage unit 114 (Step S316).

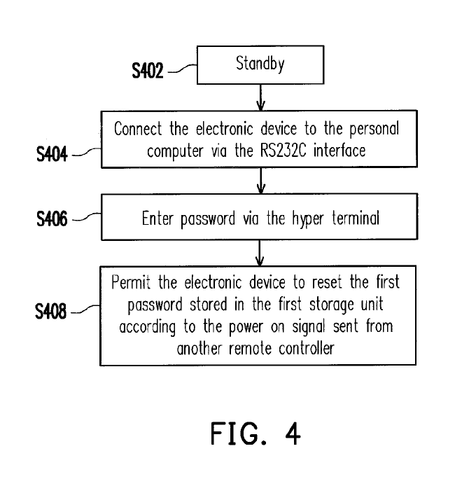

Referring to both FIGS. 1 and 4, FIG. 4 is a flowchart of a process of resetting the first password 116 according to an embodiment of the invention. When the user wants to reset the first password 116, the electronic device 110 is in the standby mode (Step S402). Thereafter, the user connects a Hyper terminal 192 of a personal computer 190 to a RS232C interface 126 of the input port 122 of the electronic device 110 (Step S404), and enters a fourth password 194 (Step S406). When the electronic device 110 receives the fourth password 194 from the personal computer 190 outside, and when the fourth password 194 and the third password 118 are the same, the electronic device 110 is permitted to reset the first password 116 stored in the first storage unit 114 according to a power on signal 150 sent from another remote controller 180 (Step S408). The hardware structure of the remote controller 180 is the same as that of the remote controller 170, and a difference therebetween is that the second storage unit 176 of the remote controller 180 stores a fifth password 188 but not the second password 178. Moreover, the fifth password 188 may be different or the same as the second password 178. In the Step S408, when the first password 116 in the first storage unit 114 is reset, the electronic device 110 replaces the first password 116 originally stored in the first storage unit 114 with the fifth password 188 in the power on signal 150. After the above-described process of resetting the first password 116, the user could startup the electronic device 110 and remotely control the operation of the electronic device 110 through the remote controller 180.

In view of the foregoing, in the embodiments of the invention described above, the password in the power on signal of the remote controller used to control the electronic device is compared with the password of the electronic device. Only when the two passwords are the same, the remote controller is permitted to remotely control the electronic device. Moreover, by determining whether the user is using the correct remote controller to power on the electronic device according to the password in the power on signal of the remote controller, an anti-theft function is achieved. Additionally, the first password could be reset so that the original remote controller may be replaced by a new remote controller.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

Each of the terms “first”, “second”, and “third” is only a nomenclature used to modify its corresponding element. These terms are not used to set up the upper limit or lower limit of the number of elements, wherein the element is, for example, a storage unit.

1. An electronic system, comprising:
an electronic device having a first storage unit for storing a first password; and
a remote controller for controlling an operation of the electronic device, the remote controller comprising:
a switch module for generating a power on signal having a power on command and a second password; and
a transmission module for transmitting the power on signal to the electronic device;
wherein the electronic device decodes the power on command and the second password of the power on signal, and compares the first password stored in the first storage unit with the second password decoded by the electronic device, when the first password and the second password are the same, the electronic device is permitted to complete a power on operation according to the power on command.

2. The electronic system as claimed in claim 1, wherein when the electronic device receives the power on signal, the electronic device checks whether the first password is stored in the first storage unit, and if the first password is not stored in the first storage unit, then the electronic device makes the second password of the power on signal be stored in the first storage unit to serve as the first password.

3. The electronic system as claimed in claim 1, wherein when the electronic device consecutively compares the first password with the second password and results in a frequency of consecutive incorrect password entries over a predetermined frequency, the electronic device maintains in a standby mode.

4. The electronic system as claimed in claim 1, wherein the first storage unit further stores a third password, and when the electronic device receives a fourth password from outside and the fourth password matches with the third password, the electronic device is permitted to reset the first password by storing a fifth password in the first storage unit to serve as the first password according to a power on signal sent from another remote controller, and the power on signal has a power on command and the fifth password.

5. The electronic system as claimed in claim 1, wherein the remote controller has a second storage unit for storing the second password.

6. A method for controlling an electronic system, the electronic system having an electronic device and a remote controller, and the electronic device having a first storage unit for storing a first password, the method comprising:
pressing a switch module of the remote controller to generate a power on signal having a power on command and a second password;
wirelessly transmitting the power on signal to the electronic device through a transmission module of the remote controller;
controlling the electronic device to decode the power on command and the second password of the power on signal;
controlling the electronic device to compare the first password stored in the first storage unit with the second password decoded by the electronic device; and
when the first password and the second password are the same, permitting the electronic device to complete a power on operation according to the power on command.

7. The method as claimed in claim 6, further comprising:
when the electronic device receives the power on signal, controlling the electronic device to check whether the first password is stored in the first storage unit; and
when the first password is not stored in the first storage unit, controlling the electronic device to store the second password of the power on signal in the first storage unit to serve as the first password.

8. The method as claimed in claim 6, further comprising:
when the electronic device consecutively compares the first password with the second password and results in a frequency of consecutive incorrect password entries over a predetermined frequency, maintaining the electronic device in a standby mode.

9. The method as claimed in claim 6, wherein the first storage unit further stores a third password, and when the electronic device receives a fourth password from outside and the fourth password matches with the third password, the electronic device is permitted to reset the first password by storing a fifth password in the first storage unit to serve as the first password according to a power on signal sent from another remote controller, and the power on signal has a power on command and the fifth password.

10. The method as claimed in claim 6, wherein the remote controller has a second storage unit for storing the second password.
